(19) United States
(12) Patent Application Publication
(10) Pub. No.: US 2010/0209872 A1
(43) Pub. Date: Aug. 19, 2010

(54) ROTOR FOR AN ELECTRIC MOTOR, ELECTRIC MOTOR AND DENTISTRY HANDPIECE

(75) Inventors: Bernhard Kuhn, Biberach (DE); Alexander Klee, Biberach (DE); Thomas Classen, Hebertingen (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KALTENBACH & VOIGHT GMBH, BIBERACH (DE)

(21) Appl. No.: 12/738,670

(22) PCT Filed: Oct. 8, 2008
(86) PCT No.: PCT/EP08/08485

§ 371 Date: Apr. 19, 2010

(30) Foreign Application Priority Data
Oct. 19, 2007 (DE) 10-2007-050.161.9
Dec. 21, 2007 (DE) 10-2007-062-010.3

(51) Int. Cl. A61C 1/06; H02K 1/28

(52) U.S. Cl. 433/131; 310/156.28

(57) ABSTRACT

The rotor for an electric motor used with a dental handpiece has a shaft with a rotational axis and a magnet arranged around the rotational axis. A centering element may be rigidly connected to the shaft or constructed as part of the shaft. The centering element presses on the magnet from the outside to center it in relation to the rotational axis of the shaft. The centering element may be pressed or shrunk on to two balancing rings. The balancing rings can be pressed or shrunk on the shaft. This allows precise centering of the magnet with respect to the rotational axis of the shaft to be achieved. The pressure exerted by the centering element on the magnet counteracts centrifugal forces during rotor rotation. Particularly high speeds may be achieved without the surface of the magnet exceeding a critical tensile stress.

The invention relates to a rotor for an electric motor, a corresponding electric motor and a dental handpiece with an electric motor of this kind.

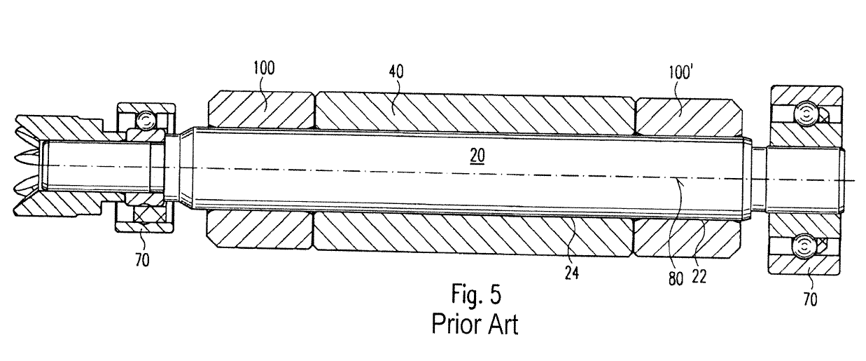

As sketched in FIG. 5, a rotor of an electric motor, for example in the form of a collectorless electric motor, normally comprises a shaft 20, on which a magnet 40 is arranged between two balancing rings 100, 100′. Two ball bearings 70, arranged on the shaft 20 around the two balancing rings 100, 100′, serve as bearings. Revolution of the rotor takes place around the rotational axis 80 of the shaft 20 and can be further transmitted from the shaft 20 on to a further shaft either via a coupling system or via a toothed wheel. The balancing rings 100, 100′ serve to compensate for imbalances of the rotor on two levels.

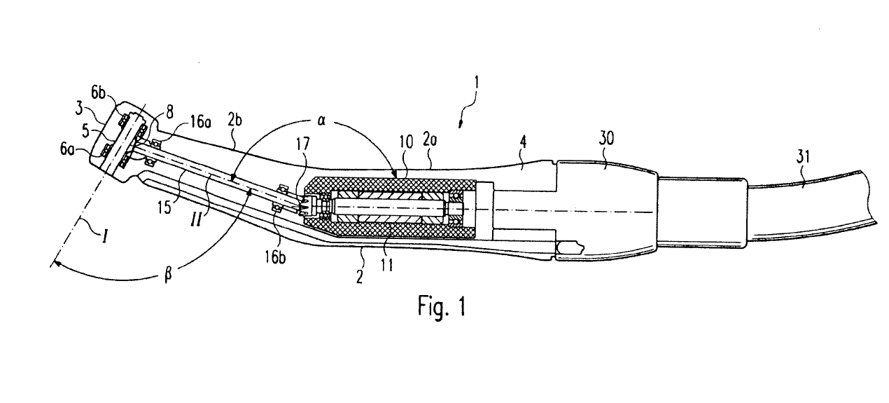

Collectorless electric motors of this kind are used, for example, for driving dental apparatus, for example dental handpieces, for example in the form of motorized dental angled pieces. A dental handpiece 1 of this kind with a corresponding electric motor 10 is sketched in FIG. 1.

The higher the maximum speed of the rotor is, the more significant are the balancing quality of the rotor and the coaxiality or the radial run-out of the components. An imbalance leads to increased strain on the ball bearings 70 and to stronger noise development.

From the prior art it is known in this context to configure the fits between the balancing rings 100, 100′ and the shaft 20 as press fits or a press bond, in order to achieve that the rotational axes of the said components are aligned as well as possible or deviate from one another as little as possible.

A corresponding press fit between the magnet 40 of the rotor and the shaft 20 is not customary, however, in particular for the following two reasons: firstly the materials from which appropriate magnets are made are to a certain extent brittle and are inclined to crack above a certain tensile loading. To some extent a tensile loading would already arise when the magnet is pressed on. Moreover, on rotation, centrifugal forces arise, which likewise result in tensile loading of the magnet. Considered overall, the loading of the magnet would in this sense be too great. Secondly, the thermal expansion coefficient of the material of which the shaft consists—steel, for example—normally differs significantly from that of the material of which the magnet consists. Generally the magnet expands in heat less than the shaft. For this reason, in the case of a press fit of the magnet on the shaft there would be a danger that the press bond would be intensified to such an extent that when heated the magnet 40 might split or burst.

Owing to the interrelations depicted, according to the prior art it is customary to glue the magnet 40 on the shaft 20, so that an adhesive bond 24 is therefore formed. The adhesive bond 24 causes an adhesive gap in which glue is placed. Because of the adhesive bond 24 too great a tensile stress can be avoided and the adhesive layer of the adhesive bond 24 located in the adhesive gap can, when heated, compensate for the different expansion behavior of the shaft 20 on the one hand and the magnet 40 on the other.

However, this technique still has problems with gluing the magnet 40 exactly centrally on the shaft 20, in particular centrally in such a way that the symmetrical axis of the magnet 40 neither has a cross-misalignment to the rotational axis 80 of the shaft 20, nor is it diagonal thereto. In order to keep any potential error caused by this as small as possible, it is therefore further customary in this case to dimension the adhesive gap provided between the magnet 40 and the shaft 20 for the gluing as small as possible. This in turn results in narrow manufacturing tolerances for the magnet 40 and the shaft 20 and furthermore means that only adhesives of particularly low viscosity can be used.

It must therefore be expected that the adhesive gap of the adhesive bond 24 is formed more or less asymmetrically in relation to the rotational axis 80 of the shaft 20. The hereby arising error in concentricity or the thereby resulting imbalance then require later balancing. Sometimes the surface of the magnet 40 is also ground again after gluing and before balancing on the shaft. The effect of this is that the magnet 40 runs virtually true to the shaft 20 on the outside, but asymmetries of the adhesive gap cannot be eliminated in this way. The quality of the coaxiality of the magnet 40 and the shaft 20 depends appreciably on the thickness of the adhesive gap. The larger the gap, the larger the misalignment can be and the larger the “internal” imbalance.

Since with increasing speed the quality of balance plays an increasing role in the quality of the rotor, at very high speeds an “internal” imbalance, i.e. one close to the axis of this kind, can also be very disturbing.

Further known from the prior art are reinforcements for magnets of rotors which are part of a balancing ring or which surround the magnets like a sleeve. Reinforcements of this kind serve to protect the magnets, for example from corrosion or from bursting, but do not have any effect on the above-mentioned problems. The said reinforcements are glued to the magnets.

The object of the invention is to cite a rotor which enables particularly accurate and at the same time simple centering of the magnets. A corresponding object is set respectively for an electric motor with a rotor of this kind and for a corresponding dental handpiece with an electric motor of this kind.

This object is achieved by the various subject matter of the independent claims. Preferred embodiments are cited in the dependent claims.

According to the invention a rotor for an electric motor is provided, wherein the rotor has a shaft with a rotational axis and at least one magnet, arranged around the rotational axis. The rotor further has a centering element which is rigidly connected to the shaft or is constructed as part of the shaft, wherein the centering element presses on the magnet from the outside to center it in relation to the rotational axis of the shaft.

Because the centering element presses from outside on the magnet to center it, it is impossible for any inaccuracy to arise in aligning the magnet with respect to the rotational axis because of an adhesive gap between the shaft and the magnet—in contrast to the prior art. It is thus easier to achieve exact centering. Moreover, the pressure of the centering element acting on the magnet from outside counteracts centrifugal forces acting on the magnet during rotation. In this way higher speeds can be achieved without the surface of the magnet exceeding a critical tensile stress. Moreover, with the rotor according to the invention it is possible to design a larger adhesive gap between the shaft and the magnet than in the prior art, with the result that—compared with the prior art—more viscous adhesives can be used. This is advantageous because adhesives of this kind may have higher adhesive strength and may be easier to process. Furthermore, the centering element provides safeguarding of the magnet in the event of possible loss of adhesive strength between the shaft and the magnet. The compression force of the centering element on the magnet can easily be chosen in such a way that it is sufficient to transmit the torque acting on the magnet via the centering element to the shaft of the rotor.

Advantageously in the rotor the magnet is arranged on the outer circumference of the shaft.

Advantageously the centering element and the magnet are at least partially connected to one another via a press fit or a shrink fit.

Advantageously the centering element has a sleeve-like region which at least partially encompasses the magnet from outside. The sleeve-like region may have a circular-cylindrical internal wall, the diameter of which is matched in the sense of a press fit or a shrink connection to an external limiting face of the magnet, for example an external lateral face of the magnet.

Advantageously the rotor further has at least one balancing ring, arranged on the shaft, wherein the centering element is rigidly connected to the balancing ring.

The centering element and the balancing ring may in this case be made in one piece. It may also be provided that the centering element is in this case pressed on to the balancing ring or shrunk on the balancing ring.

Advantageously the balancing ring is in this case either pressed on to the shaft or shrunk on to the shaft.

Advantageously the centering element encompasses the magnet over the entire extent of the magnet along the shaft. It may however also be provided that the centering element encompasses the magnet over only part of the entire extent of the magnet along the shaft.

Advantageously an adhesive bond is provided between the shaft and the magnet.

According to a further aspect of the invention an electric motor is provided which has a rotor according to the invention.

According to yet another aspect of the invention a dental handpiece is provided which has an electric motor according to the invention.

The invention is explained in greater detail below using an embodiment and with reference to the drawings.

FIG. 1 shows an illustration of a dental handpiece in which the use of an electric motor according to the invention is envisaged.

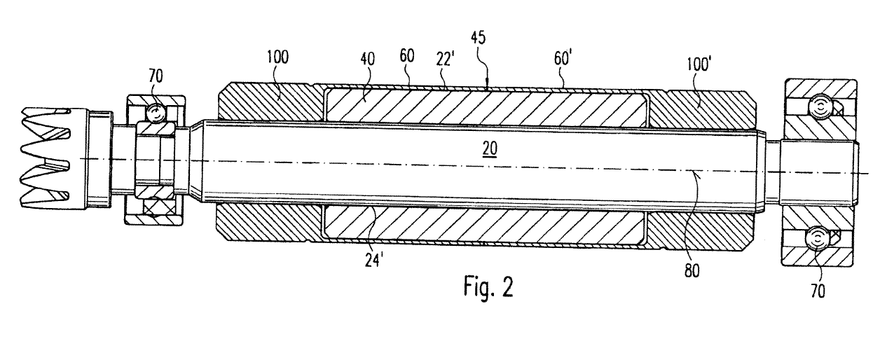

FIG. 2 shows a sectional illustration of a rotor according to the invention according to a first variant.

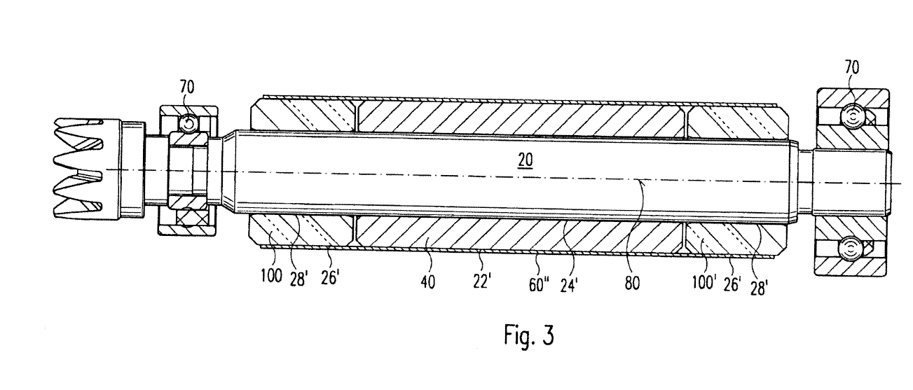

FIG. 3 shows a sectional illustration of a rotor according to the invention according to a second variant.

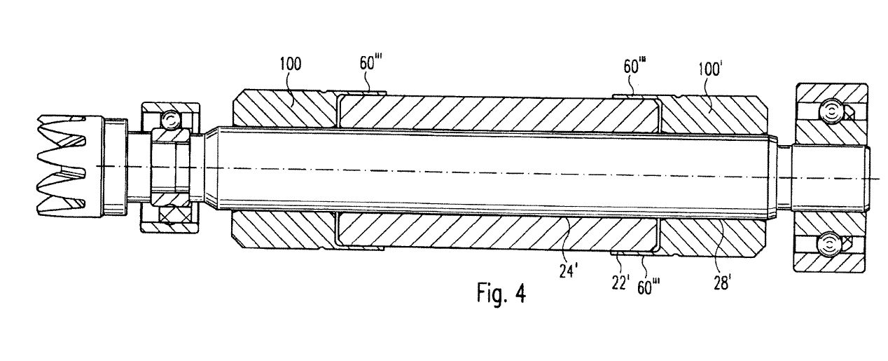

FIG. 4 shows a sectional illustration of a rotor according to the invention according to a third variant.

FIG. 5 shows a sectional illustration of a rotor according to the prior art.

The handpiece schematically illustrated in FIG. 1 and generally provided with the reference numeral 1, in which the electric motor according to the invention is used, has an elongated handle casing 2, which is divided into a rear region 2a and a front region 2b, wherein the two regions 2a, 2b enclose an angle α of approximately 155° to 170° with one another. Handling the handpiece 1 inside a patient's oral cavity is simplified by this angled design. At this point it should, though, be pointed out that the use of the electric motor according to the invention, described in greater detail below, is not confined to such so-called angled handpieces. Instead, the motor can be used generally in handpieces for dentistry, dental medicine or dental technology.

At the front end of the handle casing 2 is the head region 3 of the handpiece 1, which has a tool holder 5, held rotatably by means of two bearings 6a, 6b. This tool holder 5 is provided in particular to accommodate dental drills. For ergonomic reasons it may be further provided that the head region 3 is designed in such a way that the longitudinal axis of the tool holder 5 encloses with the axis II of the front end region 2b of the handle casing 2 an angle β of approximately 100°. The tool holder 5 is in this case set in rotation with the aid of the motor 10, described in greater detail below, the revolution of the motor 10 being transferred via a drive shaft 15 extending through the front handle casing region 2b. The drive shaft 15 is in this case held rotatably by means of two bearings 16a, 16b and at its rear end coupled via a transmission 17 to the rotor 11 of the motor 10 and at its front end via a further transmission 8 to the tool holder 5.

At the rear end of the handle casing 2 it is connected to a connecting part 30 of a supply tube 31. This tube 31 leads to a supply device (not illustrated) of a dental treatment center and serves to make available to the handpiece 1 the media needed for operation. This is in particular electricity used for operating the motor 10. Additional treatment media such as air and/or water can also be conducted to the handpiece 1 via the tube 31. Connection of the handpiece 1 is then done via a coupling element 4, located in the rear end, via which a connection to the tube connection 30 is made.

FIG. 2 shows a cross-section through a rotor according to the invention according to a first embodiment. The rotor comprises a shaft 20 with a rotational axis 80 and at least one magnet 40, arranged around the rotational axis 80. The magnet 40 in this case has at least one pair of poles effective to the outside.

The magnet 40 has a cylindrical external face, also called lateral face below, and a cylindrical internal cylindrical opening, symmetrical to the external face, the diameter of which corresponds to the external diameter of the shaft 20, so that the magnet 40 can be arranged on the shaft 20. In this embodiment the magnet 40 is therefore arranged on the external circumference of the shaft 20. The more accurate the coaxiality of the lateral face with the internal opening of the magnet 40 is, the better the present invention can work, as will become clear from the interrelations described below.

The rotor is arranged in an electric motor via two bearings, for example two ball bearings 70, in a way known per se. The electric motor may, for example, be provided in a dental handpiece for driving a dental tool, as sketched in FIG. 1 per se by the electric motor 10.

As illustrated in FIG. 2, the rotor further has a centering element 60, which is rigidly connected to the shaft 20 or can alternatively be constructed as part of the shaft 20. The centering element 60 presses on the magnet 40 from outside to center it in relation to the rotational axis 80 of the shaft 20.

The centering element 60 and the magnet 40 are connected to one another according to the embodiment by a press fit or a press bond 22′. A connection via a shrink fit may also be provided. The press bond 22′ is in this case provided on a surface of the magnet 40 which—in relation to the rotational axis 80—is a surface facing outwards. In this way the centering element 60 can act or press on the magnet 40 from outside.

The centering element 60 comprises a sleeve-like region, with an internal circular-cylindrical free space, the diameter of which in the sense of the press fit is matched to the external diameter of the magnet 40, in other words to the diameter of the lateral face of the magnet 40. The centering element 60 or the sleeve-like region therefore encompasses the magnet 40 from outside in the shape of a ring. The centering element 60 is here arranged in relation to the rotational axis 80 of the shaft 20 in such a way that the cylindrical free space is aligned symmetrically to the rotational axis 80.

The rotor further comprises a balancing ring 100, arranged on the shaft 20 directly next to the magnet 40. In the first embodiment, shown in FIG. 2, the centering element 60 is rigidly connected to the balancing ring 100 and in fact made of one piece with the balancing ring 100. The centering element 60 is therefore as it were constructed as a barrel-like extension of the balancing ring 100. Alternatively the centering element 60 could be pressed or shrunk on to the balancing ring 100 in the form of an appropriately dimensioned sleeve with a circular-cylindrical internal diameter.

The sleeve-like region of the centering element 60 is in this case arranged on the balancing ring 100 in such a way that when the balancing ring 100 is mounted the internal cylindrical free space is orientated symmetrically to the rotational axis 80.

The balancing ring 100 is in turn pressed or shrunk on to the shaft 20. In the first embodiment the rigid connection between the centering element 60 and the shaft 20 is produced in this way. The connection between the centering element 60 and the shaft 20 is in this case so rigid that the centering element 60 can form a support for the magnet 40 which fixes the magnet 40 in position with a desired accuracy with respect to the rotational axis 80 or with respect to the shaft 20 when a rotation of the rotor is provided.

Briefly summarized, the fit between the external limiting face of the magnet 40 and the internal limit of the sleeve-like region of the centering element 60 is configured as a press fit. In this way it is achieved that the magnet 40 has to be aligned with the balancing ring 100. Since the balancing ring 100 is likewise secured on the shaft 20 by a press fit, centering of the magnet 40 in relation to the rotational axis 80 of the shaft 20 is possible particularly easily and at the same time accurately. Alternatively or in addition to the press fits, corresponding connections by shrinking on, in other words shrink fits, are possible.

Put in general terms, the centering element is therefore rigidly connected to the shaft, wherein this connection does not necessarily have to be created via a balancing ring. It may also be provided, for example, that the centering element is constructed per se as barrel-like with a central opening in the base region, wherein the opening is provided directly as a connecting region to the shaft. The centering element can therefore in this case be pressed or shrunk directly on the shaft. In this case it may be provided, for example, that the centering element is arranged on the shaft directly next to the magnet. A balancing ring may then be provided on the other side of the centering element.

In the first embodiment shown two balancing rings 100, 100′ are provided, arranged on the shaft 20 on both sides of the magnet 40. The second balancing ring 100′ is constructed symmetrically to the first balancing ring 100, so that a second centering element 60′ is therefore provided and at the same time each of the two balancing rings 100, 100′ is rigidly connected to one centering element 60, 60′ in each case. By having two centering elements 60, 60′ of this kind the accuracy of the centering of the magnet 40 in relation to the rotational axis 80 can be further increased.

In the first embodiment the centering elements 60, 60′ are constructed in such a way that in the assembled state they completely encompass the magnet 40; in other words with their end faces 45 of the sleeve-like regions overlapping the magnet 40 they impact against one another or are directly adjacent to one another. The magnet 40 is in this case therefore completely encompassed, so that in addition to the centering function also a safety function, for example against breaking off or bursting of the magnet 40, can be achieved by the centering elements 60, 60′.

An adhesive bond 24′ is provided between the shaft 20 and the magnet 40 in the first embodiment.

Since the internal diameter of the magnet 40 is formed symmetrically to the external limiting face of the magnet 40, in other words to the lateral face, and also the external limiting face of the shaft 20 is constructed symmetrically to the rotational axis 80, it emerges that because of the arrangement according to the invention the gap between the magnet 40 and the shaft 20 needed for the adhesive of the adhesive bond 24′ is of necessity equally strong at all points and symmetrical to the rotational axis 80.

Therefore in particular no axial misalignment can arise between the magnet 40 and the shaft 20 and thus no corresponding imbalance either.

The arrangement according to the invention is additionally advantageous in relation to the absolute width of the adhesive gap of the adhesive bond 24′ between the magnet 40 and the shaft 20. Since by comparison with the above-described prior art the centering of the magnet 40 now no longer has to be created via as small a gap as possible, a wider gap can be chosen, which further results in adhesives also being able to be used which in comparison to the prior art are more viscous, in other words in general also adhesives which may have more adhesive strength and/or can be better processed.

The compressive stress exerted on the magnet 40 by the two centering elements 60, 60′ also has an advantageous effect. A critical speed, at which the magnet 40 fails mechanically because of centrifugal forces, is increased by the compressive stresses induced with the centering elements. The tensile stresses arising because of centrifugal forces can therefore be reduced by the centering elements. Safeguarding against splitting or bursting of the magnet 40 at a specific operational speed can in this way be increased. For example, it is thus possible for fluctuations in mechanical parameters of the material of the magnet 40 to be better “absorbed”.

In this way, therefore, particularly high speeds can be enabled, without the surface of the magnet 40 exceeding a critical tensile stress. In this respect too it is therefore favorable if the centering elements 60, 60′ completely encompass the magnet 40—in other words over the entire extent of the magnet 40 along the rotational axis 80—as provided in the first embodiment.

The invention additionally provides a safeguarding function against loss of adhesive strength between the shaft 20 and the magnet 40, for the force of pressure between the centering elements 60, 60′ and the magnet 40, acting through the press bond 22′, is sufficient to transmit a torque effectively from the magnet 40 to the shaft 20. The invention therefore also functions in particular in the event of no direct mechanical connection being provided between the internal opening of the magnet 40 and the region of the external face of the shaft 20 located in this opening.

The centering element 60 may be designed in such a way that it fulfils a reinforcing function, in other words provides protection against the magnet 40 breaking off. This can be achieved by appropriate choice of a suitable material for the centering element and suitable choice of the thickness or shape.

In FIG. 3 a second embodiment is shown. Only the differences from the first embodiment will be examined below.

In the second embodiment a centering element 60″ is provided, which is sleeve-shaped and projects beyond the magnet 40 over its entire longitudinal extent along the rotational axis 80. A press bond 22′ or shrink bond is again provided between the centering element 60″ and the magnet 40.

In the regions in which the centering element 60″ projects beyond the magnet 40 on both sides the centering element 60″ is in each case rigidly connected to one of the two balancing rings 100, 100′, once again via a press bond 26′. Alternatively the centering element 60″ may be shrunk on to the two balancing rings 100, 100′.

The two balancing rings 100, 100′ are in each case rigidly connected to the shaft 20 via a press bond 28′. Alternatively the balancing rings 100, 100′ may be shrunk on the shaft 20.

In contrast to the first embodiment, here therefore only one centering element 60″ is provided, wherein this centering element 60″ projects beyond the magnet 40. The centering element 60″ as it were forms a centering sleeve which spans the two balancing rings 100, 100′. The magnet 40 is in this case pressed into the centering sleeve.

Since the centering element 60″ is rigidly connected to the shaft 20 via the balancing rings 100, 100′, the advantageous centering effect on the magnet 40 can again be achieved.

Moreover, the continuous design of the centering element 60″ enables a particularly good additional safeguarding function, because—in relation to the longitudinal extent of the rotational axis 80—no gap is formed at the level of the magnet 40.

An adhesive bond 24′ may again be provided between the magnet 40 and the shaft 20.

To produce the rotor it may be provided in this case that firstly the magnet 40 is pressed into the centering element 60″ or into the centering sleeve, in a following step the thus formed component is then pushed on to the shaft 20, with the application of adhesive, and in a further following step the two balancing rings 100, 100′, which have a press or shrink fit to both the centering sleeve and the shaft 20, are then pressed in. In the last-mentioned step the centering element 60″ is centered with respect to the shaft 20 and therefore also the magnet 40 with respect to the shaft 20. In this case it is advantageous if an adhesive is chosen which has an appropriately long hardening time.

As in the first embodiment, here too the connection between the centering element 60″ and the shaft 20 does not necessarily have to take place via a balancing ring 100 or via the balancing rings 100, 100′. Instead of the balancing rings 100, 100′, correspondingly symmetrically formed ring-shaped components may be provided.

In FIG. 4 a third embodiment is shown. As in the first embodiment here again two centering elements 60″′ are provided, which are rigidly connected in each case to a balancing ring, in other words, for example—as shown in FIG. 4—in each case are made from one piece with the respective balancing ring 100, 100′. Alternatively a connection could again be provided via a press bond or shrinking.

In contrast to the first embodiment, in the mounted state the two centering elements 60″′ do not, however, extend over the entire longitudinal extent of the magnet 40 along the rotational axis 80, but encompass the magnet 40 only in its respective peripheral sections. The centering function of the centering elements 60″′ is also fulfilled here because of the symmetrical relations. The advantageous effect of the compressive stress acting on the magnet 40 from outside, by contrast with the first embodiment, covers a smaller area, but acts in the two peripheral regions of the magnet 40 and it is precisely there that the edges are located, which are particularly sensitive and are more inclined to break off.

It should be pointed out once again that in all the embodiments illustrated a different ring-like element or different ring-like elements can be used instead of the balancing ring 100 or instead of the balancing rings 100, 100′.

Since the concentricity behavior of an electric motor can be advantageously influenced with the invention and this effect gains significance with increasing speed, the invention is particularly suitable for high-revving motors, for example for high-revving dental motors. For example, 30,000 to 200,000 revs/min may be cited as the speed range of a motor of this kind, wherein numbers of revolutions of above 200,000 revs/min may be envisaged.

### LIST OF REFERENCE NUMERALS

1 Handpiece

2 Handle casing

2a rear region of handle casing

2b front region of handle casing

3 head area of handpiece

4 coupling element

5 tool holder

6a, 6b bearing of tool holder

8 further transmission

10 electric motor

11 rotor

15 drive shaft

16a, 16b bearing of drive shaft

17 transmission

20 shaft of rotor

22 press bond between balancing ring and shaft (prior art)

22′ press bond between centering element and magnet

24, 24′ adhesive bond

26′ press bond between centering element and balancing ring

28′ press bond between balancing ring and shaft

30 connecting part

31 supply tube

40 magnet

45 front face of centering element

60, 60′ centering element (first embodiment)

60″ centering element (second embodiment)

60″ centering element (third embodiment)

70 ball bearing

80 rotational axis of the shaft of the rotor

100, 100′ balancing rings

1. Rotor for an electric motor, wherein the rotor comprises:
a shaft with a rotational axis;
at least one magnet arranged around the rotational axis; and
a centering element that is rigidly connected to the shaft or is constructed as part of the shaft;
wherein the centering element presses on the magnet from an outside surface of the magnet to center the magnet in relation to the rotational axis of the shaft.

2. Rotor according to claim 1, in which the magnet is arranged on the external circumference of the shaft.

3. Rotor according to claim 1, in which the centering element and the magnet are at least partially connected to one another via one of a press fit or a shrink fit.

4. Rotor according to claim 1, in which the centering element has a sleeve-like region which at least partially encompasses the magnet from outside.

5. Rotor according to claim 1, further having at least one balancing ring, arranged on the shaft, wherein the centering element is rigidly connected to the balancing ring.

6. Rotor according to claim 5, in which the centering element and the balancing ring are made in one piece.

7. Rotor according to claim 5, in which the centering element is pressed on to the balancing ring or shrunk on the balancing ring.

8. Rotor according to claim 7, in which the balancing ring is pressed on the shaft or shrunk on the shaft.

9. Rotor according to claim 1, in which the centering element encompasses the magnet over the entire extent of the magnet along the shaft.

10. Rotor according to claim 1, in which the centering element encompasses the magnet over only part of the entire extent of the magnet along the shaft.

11. Rotor according to claim 1, in which an adhesive bond is provided between the shaft and the magnet.

12. Electric motor having a rotor, wherein the rotor comprises:
a shaft with a rotational axis;
at least one magnet arranged around the rotational axis; and
a centering element which is rigidly connected to the shaft or is constructed as part of the shaft;
wherein the centering element presses on the magnet from an outside surface of the magnet to center the magnet in relation to the rotational axis of the shaft.

13. Dental handpiece having an electric motor, the electric motor including a rotor, wherein the rotor comprises:
a shaft with a rotational axis;
at least one magnet arranged around the rotational axis; and
a centering element which is rigidly connected to the shaft or is constructed as part of the shaft;
wherein the centering element presses on the magnet from an outside surface of the magnet to center the magnet in relation to the rotational axis of the shaft.
